(19) United States
(12) Patent Application Publication
(10) Pub. No.: US 2007/0205294 A1
(43) Pub. Date: Sep. 6, 2007

(54) VENTILATION SYSTEM AND METHOD OF USING THE VENTILATION SYSTEM

(76) Inventors: Kenneth C. Byczynski, Holly, MI (US); Robert A. Powell, Rochester Hills, MI (US)

Correspondence Address: HOWARD & HOWARD ATTORNEYS, P.C., THE PINEHURST OFFICE CENTER, SUITE #101, 39400 WOODWARD AVENUE, BLOOMFIELD HILLS, MI, 48304-5151, US

(21) Appl. No.: 11/532,350

(22) Filed: Sep. 15, 2006

Related U.S. Application Data
(60) Provisional application No. 60/717,382, filed on Sep. 15, 2005.
(60) Provisional application No. 60/717,383, filed on Sep. 15, 2005.
(60) Provisional application No. 60/597,129, filed on Nov. 11, 2005.

(51) Int. Cl. F24F 3/14; B01F 3/02; F24F 11/00

(52) U.S. Cl. 236/44 C; 454/256; 236/44 R

(57) ABSTRACT

A ventilation system for regulating atmospheric communication between a first space and a second space includes an airflow regulation device and a control system. The airflow regulation device is disposed in fluid communication with the first and second spaces. The airflow regulation device includes a regulator for regulating airflow and an adjustment system connected to the regulator for adjusting the regulator. The control system includes a first sensor, a second sensor and a microcontroller. The first sensor is in fluid communication with the first space to measure a first atmospheric condition. The second sensor is disposed in fluid communication with the second space to measure a second atmospheric condition. The microcontroller is in communication with the first sensor and the second sensor for comparing the atmospheric conditions. The microcontroller is in communication with the adjustment system for adjusting the regulator in response to differences between atmospheric conditions.

### CROSS REFERENCE TO RELATED APPLICATION

This application claims the benefit of U.S. Provisional Application Ser. No. 60/717,382 filed Sep. 15, 2005; U.S. Provisional Application Ser. No. 60/717,383 filed Sep. 15, 2005; and U.S. Provisional Application Ser. No. 60/597,129 filed Nov. 11, 2005, the entire specifications of all of which are expressly incorporated herein by reference.

### FIELD OF THE INVENTION

The present invention generally relates to a ventilation system and a method of using the ventilation system.

### BACKGROUND OF THE INVENTION

Traditionally, vents are mounted in a roof of a building and extend through the roof between an attic and an exterior of the building. The vents allow the flow of air between the attic and the exterior of the building to maintain a low temperature and a low humidity within the attic of the building. The low temperature of the air in the attic is important in winter months to prevent ice dams. In other words, if the temperature of the attic is too high relative to the snow on the roof, the snow will melt and the water from the melted snow will flow down the roof and refreeze as ice. The refreezing ice causes damage to the roof and eventually leads to water intrusion and mold growth. The low temperature of the air in the attic is important in the summer months to aid in the efficiency of the cooling of the building. Low humidity of the air in the attic prevents condensation and mold growth in the attic.

Traditionally, vents may be convection driven vents. Convection driven vents allow the flow of air between the attic and the exterior of the building whereby the flow of the air is driven by convection. To adequately cool an attic, a plurality of convection driven vents must be mounted to the roof of the building. In addition, if the shape of the attic is complex, stagnant portions of the attic may be defined where air does not naturally flow.

A power vent includes a fan mounted in the vent to force air to move between the attic and the exterior of the building. A power vent may force air into stagnant areas of an attic and may allow an increased amount of airflow. Therefore, in general, a power vent creates more air movement than a convection vent. However, a power vent requires power to drive the fan and a power vent may be inefficient if it is powered constantly. In addition, if the attic is cooler and less humid than the air of the exterior of the building, the power vent will force the warmer and more humid air from the exterior of the building to the attic thereby undesirably increasing the temperature and humidity of the air in the attic.

It is desirable to manufacture a power vent assembly that automatically controls the power to the fan by measuring the atmospheric conditions inside the attic relative to the atmospheric conditions of the exterior of the building. More specifically, it is desirable to manufacture a power vent assembly that only supplies power to the fan when the air of the exterior of the building is cooler than the air in the attic thereby decreasing the temperature of the air in the attic by forcing the cooler air from the exterior of the building to the interior of the attic, More specifically, it is desirable to manufacture a power vent assembly that only supplies power to the fan when the air in the attic exceeds a relative humidity set point and when the air of the exterior of the building contains less moisture than the air in the attic thereby only decreasing the relative humidity of the air in the attic by forcing the air containing less moisture from the exterior of the building to the interior of the attic.

### SUMMARY OF THE INVENTION

The present invention is a ventilation system for regulating atmospheric communication between a first space and a second space. The ventilation system includes an airflow regulation device and a control system. The airflow regulation device is disposed in fluid communication with the first space and the second space. The airflow regulation device including a regulator for regulating airflow between the first space and the second space and an adjustment system connected to the regulator for adjusting the regulator. The control system includes a first sensor for disposition in fluid communication with the first space to measure a first atmospheric condition of the first space. The control system further includes a second sensor for disposition in fluid communication with the second space to measure a second atmospheric condition of the second space. The control system further includes a microcontroller in communication with the first sensor and the second sensor for comparing the first atmospheric condition of the first space and the second atmospheric condition of the second space. The microcontroller is in communication with the adjustment system for adjusting the regulator in response to differences between the first atmospheric condition of the first space and the second atmospheric condition of the second space.

The present invention further includes a method of regulating atmospheric communication between the first space and the second space. The method includes measuring the first atmospheric condition of the first space, measuring the second atmospheric condition of the second space, and comparing the first atmospheric condition of the first space and the second atmospheric condition of the second space to determine differences between the first atmospheric condition and the second atmospheric condition. The method further includes adjusting the airflow regulation device in response to differences between the first atmospheric condition of the first space and the second atmospheric condition of the second space.

In accordance with a first embodiment of the present invention, a ventilation system is provided for maintaining, controlling, or regulating atmospheric communication between a first space and a second space; said ventilation system comprising: (1) an airflow regulation device for disposition in fluid communication with the first space and the second space, and (2) a control system comprising: (a) a first sensor for fluid communication with the first space to measure a first atmospheric condition of the first space; (b) a second sensor for fluid communication with the second space to measure a second atmospheric condition of the second space; and (c) a microcontroller in communication with the first sensor and the second sensor for comparing the first atmospheric condition of the first space and the second atmospheric condition of the second space and in communication with the airflow regulation device wherein the microcontroller is selectively operable to actuate or deactivate the airflow regulation device.

In accordance with a second embodiment of the present invention, a method is provided for regulating atmospheric communication between a first space and a second space with a ventilation system including an airflow regulation device disposed in fluid communication with the first space and the second space, said method comprising: (1) measuring a first atmospheric condition of the first space; (2) measuring a second atmospheric condition of the second space; (3) comparing the first atmospheric condition of the first space and the second atmospheric condition of the second space to determine differences between the first atmospheric condition and the second atmospheric condition; and (4) selectively adjusting the airflow regulation device in response to differences between the first atmospheric condition of the first space and the second atmospheric condition of the second space.

Further areas of applicability of the present invention will become apparent from the detailed description provided hereinafter. It should be understood that the detailed description and specific examples, while indicating the preferred embodiment of the invention, are intended for purposed of illustration only and are not intended to limit the scope of the invention.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is a cross-sectional view of a first building with a ventilation system;

FIG. 2 is a cross-sectional view of the first building with the ventilation system;

FIG. 3 is a cross-sectional view of a second building with the ventilation system; and

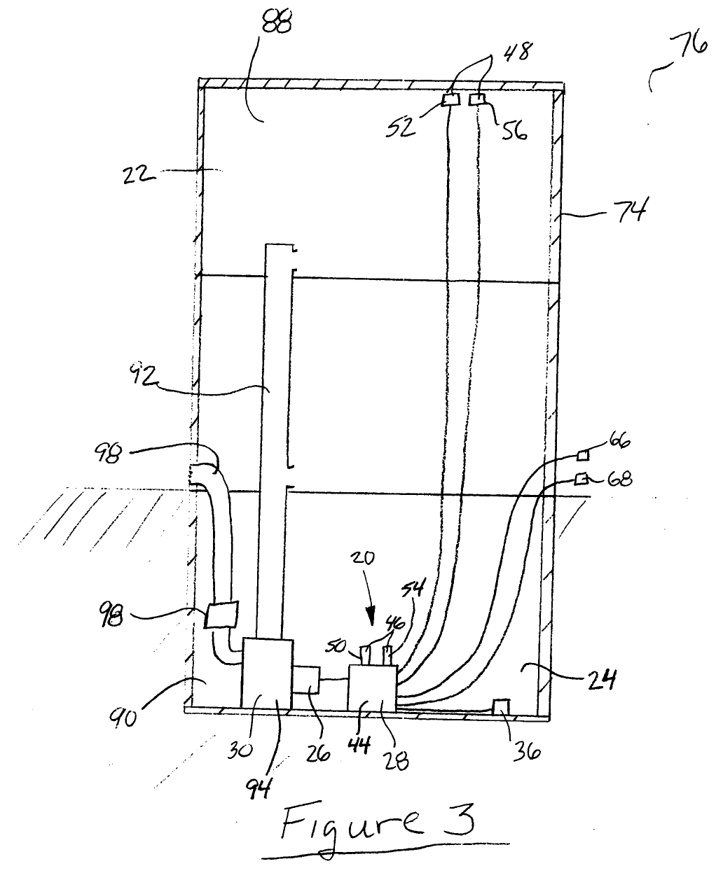

FIG. 4 is a schematic of the ventilation system.

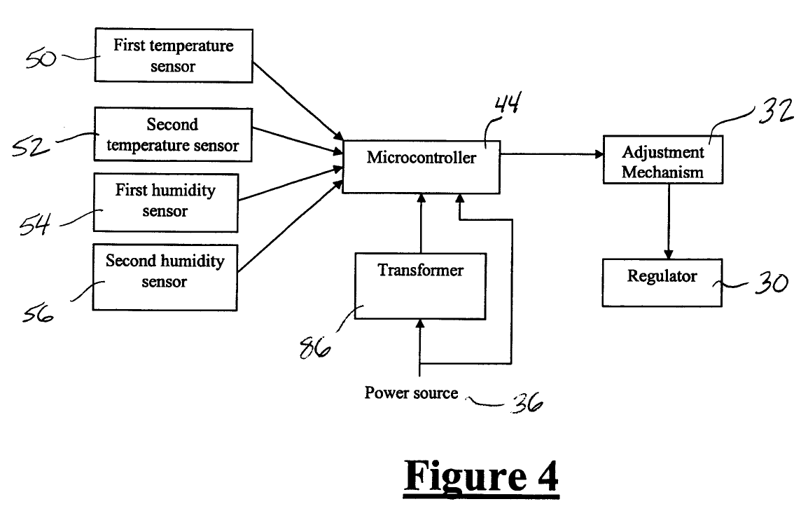

The same reference numerals refer to the same parts throughout the various Figures.

### DETAILED DESCRIPTION OF THE INVENTION

Referring to the Figures, wherein like numerals indicate corresponding parts throughout the several views, a ventilation system 20 is generally shown. The ventilation system 20 regulates atmospheric communication between a first space 22 and a second space 24. The ventilation system 20 includes an airflow regulation device 26 and an control system 28.

The airflow regulation device 26 is disposed in fluid communication with the first space 22 and the second space 24. The airflow regulation device 26 includes a regulator 30 for regulating airflow between the first space 22 and the second space 24 and, optionally, an adjustment system 32 connected to the regulator 30 for adjusting the regulator 30. It should be appreciated that the adjustment system 32 may be used alone or in combination with another component to start, stop, increase, decrease, or change direction of the airflow between the first space 22 and the second space 24.

The regulator 30 may be a fan 34 for forcing airflow between the first space 22 and the second space 24. In such a configuration, the adjustment device may be a switch connected to a power source 36. The switch is electrically connected with the fan 34 and is switchable between a powered position and an unpowered position. In the powered position, the switch allows delivery of electricity from the power source 36 to the fan 34. In the unpowered position, the switch prevents delivery of electricity from the power source 36 to the fan 34. Alternatively, the adjustment device may be a rheostat. In one aspect, the rheostat is connected to the power source 36 and is electrically connected with the fan 34. The rheostat is adjustable for adjusting the amount of electricity delivered from the power source 36 to the fan 34.

Alternatively, the airflow regulation device 26 includes a passage 38 and the regulator 30 is a baffle 40 disposed in a moveable relationship with the passage 38. Specifically, the passage 38 fluidly connects the first space 22 and the second space 24. The baffle 40 is moveable between an open position and a closed position. In the open position, the baffle 40 allows fluid communication between the first space 22 and the second space 24 through the passage 38. In the closed position, the baffle 40 prevents fluid communication between the first space 22 and the second space 24 through the passage 38. In such a configuration, the adjustment device may be a motor 42 connected to the baffle 40. The motor 42 moves the baffle 40 between the open position and the closed position in response to input from the microcontroller 44.

The control system 28 includes a first sensor 46, a second sensor 48, and a microcontroller 44. The first sensor 46 is disposed in fluid communication with the first space 22 to measure a first atmospheric condition of the first space 22. The second sensor 48 is disposed in fluid communication with the second space 24 to measure a second atmospheric condition of the second space 24.

The microcontroller 44 is in communication with the first sensor 46 and the second sensor 48. The microcontroller 44 compares the first atmospheric condition of the first space 22 and the second atmospheric condition of the second space 24. The microcontroller 44 is in communication with the adjustment system 32 for adjusting the regulator 30 in response to differences between the first atmospheric condition of the first space 22 and the second atmospheric condition of the second space 24.

For example, if the atmospheric condition of the second space 24 is more favorable than the atmospheric condition of the first space 22, the microcontroller 44 communicates with the adjustment system 32 to adjust the regulator 30 to increase atmospheric communication between the first space 22 and the second space 24. If the atmospheric conditions of the second space 24 are less favorable than the atmospheric condition of the first space 22, the microcontroller 44 communicates with the adjustment system 32 to adjust the regulator 30 to decrease atmospheric communication between the first space 22 and the second space 24.

The first sensor 46 may be a first temperature sensor 50 and the second sensor 48 may be a second temperature sensor 52. The first temperature sensor 50 measures a first temperature of air in the first space 22. The second sensor 48 measures a second temperature of air in the second space 24.

Alternatively, the first sensor 46 may be a first humidity sensor 54 and the second sensor 48 may be a second humidity sensor 56. The first humidity sensor 54 measures a first humidity of the air of the first space 22. The second humidity sensor 56 measures a second humidity of the air of the second space 24. It should be appreciated that the sensors described herein are exemplary and that the first sensor 46 and the second sensor 48 may be any type of sensor for measuring an atmospheric condition. It should be appreciated that the ventilation system may include any number of sensors for measuring atmospheric conditions. It should be appreciated that the term “humidity” as used herein may be relative humidity, absolute humidity, or the like.

The first sensor 46 may be further defined as a first plurality of sensors and the second sensor 48 may be further defined as a second plurality of sensors. For example, the first plurality of sensors may include the first temperature sensor 50 and the first humidity sensor 54 and the second plurality of sensors may include the second temperature sensor 52 and the second humidity sensor 56. It should be appreciated that the plurality of sensors described herein are exemplary and that the first plurality of sensors and the second plurality of sensors may include any number of sensors 58, 60 and any type of sensors 58, 60 for measuring atmospheric conditions.

The control system 28 may further include a dew point sensor 62 in communication with the microcontroller 44. The dew point sensor 62 is in fluid communication with the first space 22 to measure a dew point temperature of air in the first space 22.

The control system 28 may further include a relative humidity sensor 64 in communication with the microcontroller 44. The relative humidity sensor 64 is in fluid communication with the first space 22 to measure a relative humidity of air in the first space 22.

The subject invention also includes a method of regulating atmospheric communication between the first space 22 and the second space 24 with the ventilation system 20. The method includes measuring the first atmospheric condition of the first space 22, measuring a second atmospheric condition of the second space 24, and comparing the first atmospheric condition of the first space 22 and the second atmospheric condition of the second space 24 to determine differences between the first atmospheric condition and the second atmospheric condition. The method further includes adjusting the airflow regulation device 26 in response to differences between the first atmospheric condition of the first space 22 and the second atmospheric condition of the second space 24.

The method further includes measuring the first temperature of air in the first space 22 and measuring the second temperature of air in the second space 24. The method further includes comparing the first temperature and the second temperature. The adjusting the airflow regulation device 26 may be further defined as increasing communication between the first space 22 and the second space 24 when the first temperature is less than the second temperature.

The method further includes measuring the first humidity of air in the first space 22 and measuring the second humidity of air in the second space 24. The method further includes comparing the first temperature and the second temperature and comparing the first humidity and the second humidity. Adjusting the airflow regulation device 26 may be further defined as increasing communication between the first space 22 and the second space 24 when the first temperature is greater than the second temperature and the first humidity is less than the second humidity.

The method further includes prioritizing between temperature and humidity to determine to determine the adjustment of the airflow regulation device 26. In other words, the microcontroller 44 performs a predetermined sequence to prioritize whether the first temperature or the first humidity has a higher priority. The priority determines whether the airflow regulation device 26 increases or decreases atmospheric communication between the first space 22 and the second space 24. For example, if the microcontroller 44 determines that the first temperature has priority, atmospheric communication will not be increased unless the first temperature is unsatisfactory regardless of whether the first humidity is satisfactory or unsatisfactory. It should be appreciated that the microcontroller 44 may determine priority of any atmospheric condition including, but not limited to, temperature, humidity, and/or pressure.

The method further includes measuring the dew point temperature of the air of the first space 22. Adjusting the airflow regulation device 26 may be further defined as decreasing communication between the first space 22 and the second space 24 when the dew point temperature of air of the first space 22 is less than or equal to the dew point temperature of the air of the second space 24.

The method further includes measuring a relative humidity of air of the first space 22. Adjusting the airflow regulation device 26 may be further defined as increasing communication between the first space 22 and the second space 24 when the first relative humidity is greater than or equal to a relative humidity set point.

Adjusting the airflow regulation device 26 may be further defined as supplying electricity to the fan 34. Alternatively, adjusting the airflow regulation device 26 may be further defined as moving the baffle 40 between the open position and the closed position, or any position therebetween. The baffle 40 is moved to the open position to allow atmospheric communication between the first space 22 and the second space 24. The baffle 40 is moved to the closed position to prevent atmospheric communication between the first space 22 and the second space 24.

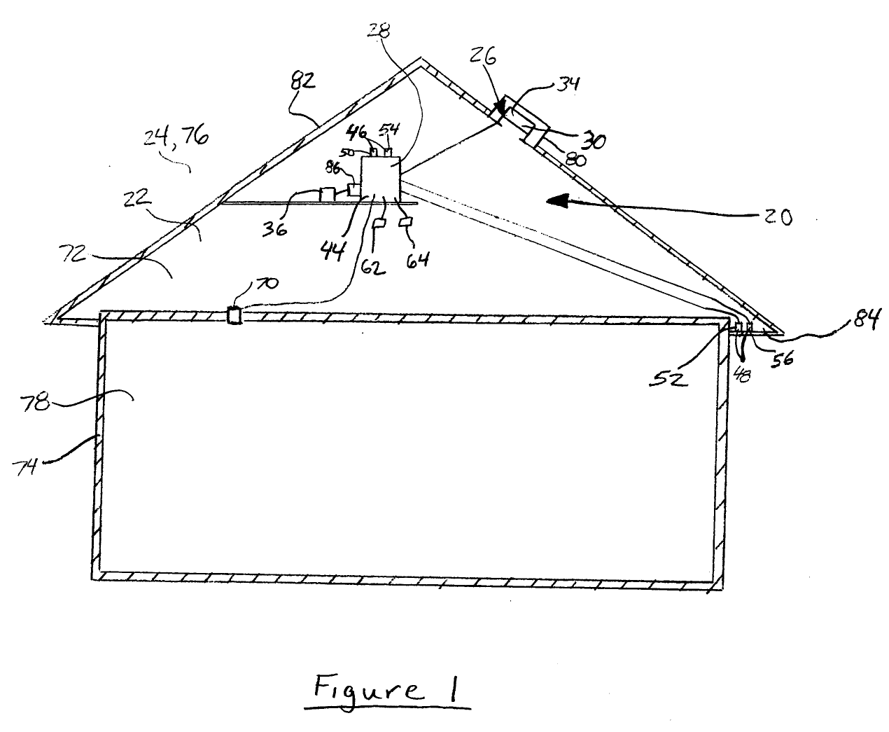

In a first embodiment, as shown in FIG. 1, the first space 22 is further defined as an attic 72 of a building 74, such as a residential or commercial building 74, and the second space 24 is further defined an exterior 76 of the building 74. The ventilation system 20 may be mounted in the attic 72 of a building 74. In such a configuration, the ventilation system 20 may regulate the temperature, humidity, and/or pressure of the attic 72 relative to the temperature, humidity, and/or pressure of the air of the exterior 76 of the building 74. The ventilation system 20 may be installed during the construction of a building 74 or may be installed to currently existing buildings 74. It should be appreciated that the ventilation system 20 is not limited to residential or commercial buildings 74, but may be mounted in any structure to control the temperature, humidity, and/or pressure of the interior 78 of the structure relative to the temperature and humidity of the air of the exterior 76 of the structure. It should be appreciated that the interior 78 may refer to any discrete portion of the interior 76 of the structure.

In the first embodiment, the regulator 30 and the adjustment device may be mounted in a vent 80. The attic 72 of the building 74 is defined by a roof 82 and the vent 80 is mounted to the roof 82 and extends through the roof 82 between the attic 72 and the exterior 76 of the building 74. The regulator 30 is disposed in the vent 80 such that the regulator 30 may increase or decrease atmospheric communication through the vent 80 between the attic 72 and the exterior 76 of the building 74.

The first temperature sensor 50 and the first humidity sensor 54 are disposed in the attic 72 and measure the temperature and the humidity, respectively, of the air in the attic 72. The second temperature sensor 52 and the second humidity sensor 56 are exposed to the exterior 76 of the building 74 and measure the temperature and the humidity, respectively, of the air of the exterior 76 of the building 74. For exemplary purposes, the second temperature sensor 52 and the second humidity sensor 56 may be mounted below a vent cover 80 on the exterior 76 of a roof 82 or in a soffit vent 84 of the building 74 such that the sensors are exposed to the temperature and humidity of the air of the exterior 76 of the building 74. Preferably the second temperature sensor 52 and the second humidity sensor 56 are not directly exposed to the elements, which may cause incorrect measurements.

In the first embodiment, the microcontroller 44 is disposed in the attic 72 of the building 74 and may be connected by electrical wire to the regulator 30 and the sensors. Alternatively, the microcontroller 44 may communicate wirelessly with the regulator 30 and the sensors. A transformer 86 may be disposed between the power source 36 and the microcontroller 44 such that the transformer 86 provides a low voltage, e.g. 9V, to the microcontroller 44 to operate the microcontroller 44. The power source may be, e.g., a 120V AC duplex outlet. The transformer 86 may be connected by electrical wire to the microcontroller 44. Alternatively, the microcontroller 44 may be directly connected to the power source 36.

The microcontroller 44 controls the regulator 30 depending upon the conditions of the air in the attic 72 in relation to the condition of the air of the exterior 76 of the building 74. For example, the microcontroller 44 may control electrical current supplied to the adjustment device such that the adjustment device allows the regulator 30 to allow or prevent atmospheric communication between the attic 72 and the exterior 76 of the building 74. Specifically, the microcontroller 44 is programmed with a computer program. The microcontroller 44 uses the computer program to determine whether current should be applied to the regulator 30.

Specifically, a relative humidity set point is based upon building 74 code requirements and other factors. The microcontroller 44 uses, among other things, the measurements of the temperature and humidity of the air of the attic 72 to calculate the relative humidity of the air of the attic 72. When the temperature of the air in the attic 72 is greater than the temperature of the air of the exterior 76 of the building 74 and the relative humidity of the air in the attic 72 is less than the relative humidity set point, the microcontroller 44 supplies electrical current to the regulator 30 and the regulator 30 increases atmospheric communication between the exterior 76 of the building 74 and the attic 72 to decrease the temperature of the air in the attic 72. Conversely, when the temperature of the air of the exterior 76 of the building 74 is greater than the temperature air in the attic 72 and the relative humidity of the air in the attic 72 is less than the relative humidity set point, the microcontroller 44 generally does not supply electrical current to the regulator 30, for example, depending upon temperature differences between the attic 72 and the exterior 76.

The microcontroller 44 compares the temperature and the relative humidity of the air in the attic 72 with the temperature and the relative humidity, respectively, of the air of the exterior 76 of the building 74 to control the regulator 30. The dew point temperature of the air of the attic 72 may be measured with the dew point sensor 62. Alternatively, the microcontroller 44 may use, among other measurements, the measurements corresponding to the temperature and the humidity of the air of the attic 72 to calculate the dewpoint temperature of the air of the attic 72.

When the relative humidity of the air in the attic 72 is greater than the relative humidity set point and the temperature of the air in the attic 72 is greater than the dew point temperature of the air of the exterior 76 of the building 74, the microcontroller 44 supplies electrical current to the regulator 30 and the regulator 30 moves air from the exterior 76 of the building 74 to the attic 72 to decrease the relative humidity of the air in the attic 72. Conversely, when the relative humidity of the air in the attic 72 is greater than the relative humidity set point and the temperature of the attic 72 is less than the dew point temperature of the air of the exterior 76 of the building 74, the microcontroller 44 supplies electrical current to a warning light indicating the relative humidity of the attic 72 is greater than that of the relative humidity set point. However, the power is not supplied to the fan 34 to avoid an increase in the relative humidity of the air in the attic 72. Optionally, the microcontroller 44 may cause electrical current to be supplied to a warning system when the atmospheric conditions of the attic 72 are at risk of causing condensation inside the attic 72.

The first embodiment may further include a third temperature sensor 66 in fluid communication with an exterior 76 of the building 74 and a third humidity sensor 68 in fluid communication with the exterior 76 of the building 74. The third temperature sensor 66 measures a third temperature of air in the exterior 76 of the building 74 and the third humidity sensor 68 measures a third humidity of air in the exterior 76 of the building 74. The third temperature sensor 66 and the third humidity sensor 68 are in communication with the microcontroller 44.

The first embodiment may further include a pressure sensor 70 in fluid communication with the attic 72 and the interior 78 of the building 74. The pressure sensor 70 is in communication with the microcontroller 44. The pressure sensor 70 measures the relative pressure of the interior 78 of the building 74 with respect to the attic 72. The pressure of the air of the attic 72 is altered by control by the adjustment system 32 of the atmospheric communication between the attic 72 and the exterior 76 of the building 74. In other words, for example, the pressure of the air of the attic 72 may be increased relative to the pressure of the air in the interior 78 of the building 74 by controlling with the adjustment system 32 atmospheric communication between the attic 72 and the exterior 76, e.g. selectively blowing a requisite amount of air from the exterior 76 into the attic 72 or allowing free airflow from the exterior 76 to the attic 72. The pressure of the air in the attic 72 may be decreased relative to the pressure of the air in the interior 78 of the building 74 by controlling with the regulator 30 atmospheric communication, e.g., blowing air from the attic 72 to the exterior 76 or allowing free airflow from the attic 72 to the exterior 76. It should be appreciated that the pressure sensor 70 may be used to measure pressure differential between any two or more spaces.

In such a configuration, the adjustment system 32 may increase or decrease atmospheric communication between the attic 72 and the exterior 76 of the building 74 depending upon the atmospheric conditions of the attic 72 relative to the interior 78 of the building 74. Specifically, the ventilation system 20 may humidify or dehumidify the interior 78 of the building 74.

When it is desirable to humidify the interior 78 of the building 74, the ventilation system 20 may force humidity from the attic 72 to the interior 78 of the building 74. Specifically, when the humidity of the air of the attic 72 is greater than the humidity of the air of the interior 78 of the building 74, the ventilation system 20, adjusts, or increases, the pressure of the attic 72 relative to the interior 78 such that moisture migrates from the attic 72 to the interior 78.

When it is desirable to dehumidify the interior 78 of the building 74, the ventilation system 20 may force humidity from the interior 78 of the building 74 to the attic 72. For example, when the humidity of the air of the attic 72 is less than the humidity of the air of the interior 78 of the building 74, the ventilation system 20, adjusts, or decreases, the pressure of the attic 72 relative to the interior 78 such that moisture migrates from the interior 78 to the attic 72 or other suitable location depending upon the circumstances.

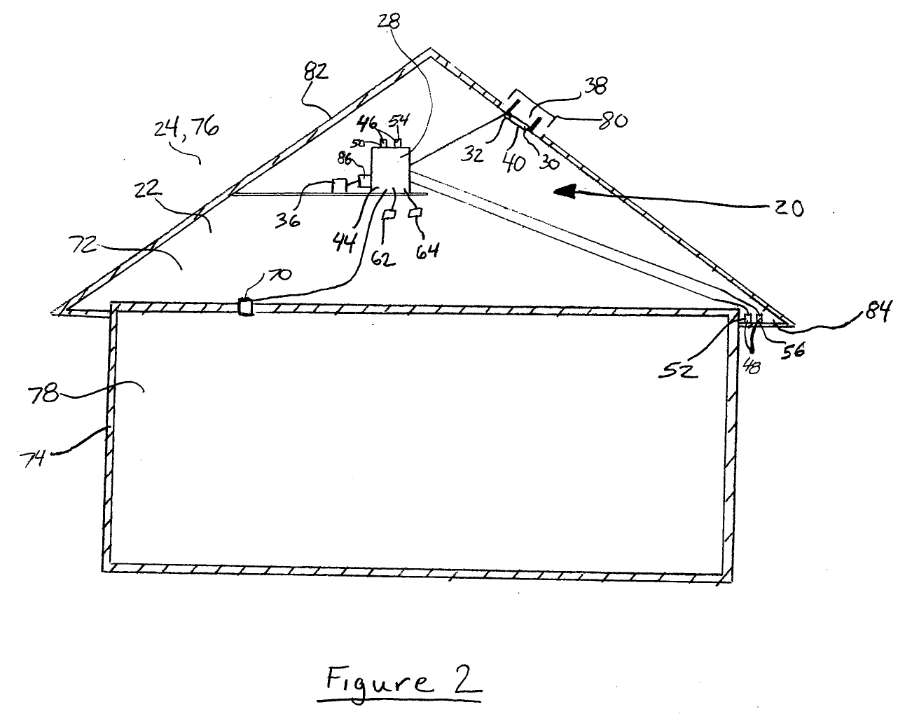

In a second embodiment, as shown in FIG. 2, the first space 22 is further defined as an upper level 88 of the building 74 and the second space 24 is further defined a lower level 90 of the building 74, such as a basement. The second embodiment may include an interior duct 92 extending between the upper level 88 and the lower level 90. In such a configuration, the ventilation system 20 may regulate the temperature of the upper level 88. For example, when the temperature of the air of the upper level 88 is above a temperature set point and the temperature of the air of the lower level 90 is less than the temperature of the air of the lower level 90, the ventilation system 20 increases atmospheric communication between the upper level 88 and the lower level 90 to decrease the temperature of the air of the lower level 90. It should be appreciated that the microcontroller 44 may consider temperature, humidity, and/or pressure in determining when the atmospheric communication should be increased or decreased.

In the second embodiment, the airflow regulation device 26 may be mounted in the interior duct 92. For example, in the second embodiment, the airflow regulation device 26 may be further defined as a furnace 94 or an air conditioner. The regulator 30 is disposed in the interior 78 vent 80 such that the regulator 30 may increase or decrease atmospheric communication through the interior 78 vent 80 between the lower level 90 and the upper level 88. For example, the regulator 30 may allow or prevent airflow through the interior 78 vent 80. Alternatively, the regulator 30 may force airflow through the interior 78 vent 80.

The ventilation system 20 may be installed during the construction of a building 74 or may be installed to currently existing buildings 74. It should be appreciated that the ventilation system 20 is not limited to residential or commercial buildings 74, but may be mounted in any structure to control the temperature of different zones of the structure.

The first temperature sensor 50 is disposed in the upper level 88 and measures the temperature of the air in the upper level 88. The second temperature sensor 52 is disposed in the lower level 90 and measures the temperature of the air of the lower level 90.

In the second embodiment, the microcontroller 44 may be connected by electrical wire to the regulator 30 and the sensors. Alternatively, the microcontroller 44 may communicate wirelessly with the regulator 30 and the sensors. The transformer 86 may be disposed between the power source 36 and the microcontroller 44 such that the transformer 86 provides a low voltage, e.g., 9V, to the microcontroller 44 to operate the microcontroller 44. The power source 36 may be, e.g., a 120V AC duplex outlet. The transformer 86 may be connected by electrical wire to the microcontroller 44. Alternatively, the microcontroller 44 may be directly connected to the power source 36.

The microcontroller 44 controls the regulator 30 depending upon the temperature of the air in the lower level 90 in relation to the temperature of the air of the upper level 88. For example, the microcontroller 44 may control electrical current supplied to the adjustment device such that the adjustment device adjusts the regulator 30 to allow or prevent atmospheric communication between the lower level 90 and the upper level 88. Specifically, the microcontroller 44 is programmed with the computer program. The microcontroller 44 uses the computer program to determine whether current should be applied to the regulator 30.

The second embodiment of the invention may further include a make-up air damper 96. Specifically, the furnace 94 includes a return air duct 98 fluidly communicative with the exterior 76 of the building 74. When the furnace 94 drives air through the interior duct 92, the furnace 94 draws air from the exterior 76 of the building 74 through the return air duct 98.

The make-up air damper 96 is disposed in the return air duct 98 and is moveable to prevent or allow airflow through the return air duct 98. Specifically, the make-up air damper 96 is in communication with the microcontroller 44 and the microcontroller 44 directs the return air duct 98, or any component disposed therein, to prevent airflow or to allow airflow through the return air duct 98 depending upon atmospheric conditions of the air of the interior 78 of the building 74 relative to atmospheric conditions of the air of the exterior 76 of the building 74. For example, when it is desirable to maintain the air of the building 74 in a dehumidified state and the humidity of the air of the exterior 76 is greater than the humidity of the air of the interior 78, the microcontroller 44 directs the make-up air damper 96 to prevent airflow through the return air duct 98 to prevent an increase in the humidity of the air of the interior 78.

The invention has been described in an illustrative manner, and it is to be understood that the terminology which has been used is intended to be in the nature of words of description rather than of limitation. Obviously, many modifications and variations of the present invention are possible in light of the above teachings, and the invention may be practiced otherwise than as specifically described.

What is claimed is:

1. A ventilation system for maintaining, controlling, or regulating atmospheric communication between a first space and a second space; said ventilation system comprising:
an airflow regulation device for disposition in fluid communication with the first space and the second space, and
a control system comprising:
a first sensor for fluid communication with the first space to measure a first atmospheric condition of the first space;
a second sensor for fluid communication with the second space to measure a second atmospheric condition of the second space; and
a microcontroller in communication with said first sensor and said second sensor for comparing the first atmospheric condition of the first space and the second atmospheric condition of the second space and in communication with said airflow regulation device wherein said microcontroller is selectively operable to actuate or deactivate the airflow regulation device.

2. The ventilation system as set forth in claim 1 wherein said airflow regulation device includes a regulator for regulating airflow between the first space and the second space and an adjustment system connected to said regulator for adjusting said regulator;

3. The ventilation system as set forth in claim 2 wherein said regulator is a fan for forcing airflow between the first space and the second space.

4. The ventilation system as set forth in claim 3 wherein said adjustment device is a switch for connection to a power source, said switch electrically connected with said fan and switchable between a powered position for delivering electricity from the power source to said fan and an unpowered position for preventing delivery of electricity from the power source to said fan.

5. The ventilation system as set forth in claim 3 wherein said adjustment system is an adjustment device for connection to a power source, said adjustment device electrically connected with said fan for adjusting the amount of electricity delivered from the power source to said fan.

6. The ventilation system as set forth in claim 2 wherein said airflow regulation device includes a passage for fluidly connecting the first space and the second space and said regulator is a baffle disposed in a moveable relationship with said passage and moveable between an open position for allowing fluid communication between the first space and the second space through said passage and a closed position for preventing fluid communication between the first space and the second space through said passage.

7. The ventilation system as set forth in claim 6 wherein said adjustment device is a motor connected to said baffle for moving said baffle between said open position and said closed position in response to input from said microcontroller.

8. The ventilation system as set forth in claim 1 wherein said first sensor is a first temperature sensor for measuring a first temperature of air in the first space and said second sensor is a second temperature sensor for measuring a second temperature of air in the second space.

9. The ventilation system as set forth in claim 1 wherein said first sensor is a first humidity sensor for measuring a first humidity of the air of the first space said second sensor is a second humidity sensor for measuring a second humidity of the air of the second space.

10. The ventilation system as set forth in claim 1 further including a dew point sensor in communication with said microcontroller for disposition in fluid communication with the first space to measure a dew point temperature of air in the first space.

11. The ventilation system as set forth in claim 1 further including a relative humidity sensor in communication with said microcontroller for disposition in fluid communication with the first space to measure a relative humidity of air in the first space.

12. A method of regulating atmospheric communication between a first space and a second space with a ventilation system including an airflow regulation device disposed in fluid communication with the first space and the second space, said method comprising:
measuring a first atmospheric condition of the first space;
measuring a second atmospheric condition of the second space;
comparing the first atmospheric condition of the first space and the second atmospheric condition of the second space to determine differences between the first atmospheric condition and the second atmospheric condition; and
selectively adjusting the airflow regulation device in response to differences between the first atmospheric condition of the first space and the second atmospheric condition of the second space.

13. The method as set forth in claim 12 further including measuring a first temperature of air in the first space and measuring the second temperature of air in the second space.

14. The method as set forth in claim 13 further including comparing the first temperature and the second temperature and wherein adjusting the airflow regulation device is further defined as selectively increasing communication between the first space and the second space when the first temperature is less than the second temperature.

15. The method as set forth in claim 13 further including measuring a first humidity of air in the first space and measuring a second humidity of air in the second space.

16. The method as set forth in claim 15 further including comparing the first temperature and the second temperature and comparing the first humidity and the second humidity and wherein adjusting the airflow regulation device is further defined as selectively increasing communication between the first space and the second space when the first temperature is greater than the second temperature or the first humidity is less than the second humidity.

17. The method as set forth in claim 16 further including prioritizing between temperature and humidity to determine the adjustment of the airflow regulation device.

18. The method as set forth in claim 13 further including measuring a dew point temperature of the air of the first space and wherein adjusting the airflow regulation device is further defined as selectively decreasing communication between the first space and the second space when the temperature of air of the first space is less than or equal to the dew point temperature of the air of the first space.

19. The method as set forth in claim 12 further including measuring a relative humidity of air of the first space and wherein adjusting the airflow regulation device is further defined as selectively increasing communication between the first space and the second space when the first relative humidity is greater than or equal to a relative humidity set point.

20. The method as set forth in claim 12 wherein the airflow regulation device is further defined as a fan and wherein adjusting the airflow regulation device is further defined selectively supplying electricity to the fan.

21. The method as set forth in claim 12 wherein the airflow regulation device includes a passage for fluidly connecting the first space and the second space and the regulator and a baffle disposed in a moveable relationship with the passage and adjusting the airflow regulation device is further defined as selectively moving the baffle between an open position to allow atmospheric communication between the first space and the second space and a closed position to prevent atmospheric communication between the first space and the second space.
